(19) United States
(12) Patent Application Publication
(10) Pub. No.: US 2026/0252766 A1
(43) Pub. Date: Aug. 27, 2026

(54) Method and System for Selecting Circuit Models From A Circuit Model Database

(71) Applicant: Marvell Asia Pte Ltd., Singapore (SG)

(72) Inventors: Shahid Ikram, Shrewsbury, MA (US); Daniel Katz, Marlborough, MA (US); Savinaya Rajendra, Shrewsbury, MA (US); Akshaya Waingade, Marlborough, MA (US); Ejaz Ahamed Shaik, Westborough, MA (US)

(21) Appl. No.: 19/547,571

(22) Filed: Feb. 23, 2026

Related U.S. Application Data
(60) Provisional application No. 63/763,832, filed on Feb. 26, 2025.

(51) Int. Cl. G06F 30/27; G06N 3/0455

(52) U.S. Cl. CPC G06F 30/27; G06N 3/0455

(57) ABSTRACT

A method of selecting a foundational building block model from a trained dataset of foundational building block models may comprise performing a semantic similarity search of the trained dataset, based on a user specification, to produce a set of foundational building block model candidates. The specification may be conveyed to the trained dataset through an initial prompt. The method may further comprise combining the initial prompt from the user with the set of foundational building block model candidates to produce an augmented prompt, submitting the augmented prompt to a primary large language model (LLM), and receiving, from the primary LLM, a prioritized categorization of the final set of foundational building block candidates generated based, at least in part, on the specification from the user. The method may further comprise performing a multi-stage reranking of the set of foundational building block model candidates using a Bi-encoder followed by a Cross-encoder.

### RELATED APPLICATION

This application claims the benefit of U.S. Provisional Application No. 63/763,832, filed on Feb. 26, 2025. The entire teachings of the above application are incorporated herein by reference.

### BACKGROUND

Integrated circuit (IC) design is a complex and challenging process that involves the collaborative efforts of hundreds of engineers over several years. Early design decisions, including architectural, micro-architectural, register-transfer level (RTL) implementation, and physical design choices, can significantly impact the project's success or failure. To mitigate potential issues later in the design cycle, design teams have developed methodologies and best practices for the IC design process.

A crucial part of this legacy knowledge is embedded in foundational RTL modules such as, but not limited to, FIFOs, counters, and credit-counters. Over the years, teams have created hundreds of these modules, each varying in complexity. Foundational RTL models encapsulate this legacy knowledge and provide a reliable starting point for new designs, ensuring consistency, reliability, and efficiency in the design process. Many IC design teams use Verilog as their primary language. ICs are constructed hierarchically, architected from top to bottom and implemented from bottom to top, with extensive reuse of fundamental components across different paths and leaves of the hierarchy. Critical physical design features such as timing, area, and latency depend heavily on the Verilog implementation. Each subcomponent in the hierarchy impacts these features and must be selected based on high-level requirements. Therefore, choosing the right component at each level is crucial and time-consuming.

Identifying an optimal legacy RTL module among the vast array of options is a challenge, even for senior engineers. This difficulty is exacerbated by attrition, as experienced designers move on to new opportunities, leaving new hires to navigate decades of accumulated knowledge. Consequently, many new engineers end up reinventing the wheel or selecting sub-optimal modules.

### SUMMARY

The embodiments described herein are directed to a computer-based method of selecting (alternatively referred to herein as recommending) a foundational building block model from a trained dataset of foundational building blocks. Such a system for recommending a foundational RTL module from a large pool of foundational RTL modules may save a substantial amount of engineering research time and result in a RTL module selection grounded in reliable component data. A good recommendation system can be critical to success of an overall IC design process.

Knowledge-based recommendation systems use domain-specific knowledge to provide tailored suggestions, allowing precise control over search criteria. Unlike traditional systems that rely on historical user data, these systems ensure recommendations align closely with user preferences. By balancing similarity and diversity, such systems enhance user experience in specialized applications.

Retrieval-Augmented Generation (RAG) is an advanced technique that combines information retrieval with text generation to enhance the capabilities of large language models (LLMs). By integrating external knowledge sources, RAG systems may generate accurate, contextually relevant, and up-to-date responses. This approach optimizes the output of LLMs by referencing authoritative knowledge bases, ensuring that the generated content is both precise and reliable. RAG is particularly useful in applications where maintaining the relevance and accuracy of information is critical, such as in chatbots, recommendation systems, and other natural language processing tasks.

RAG enhances knowledge-based recommendation systems by integrating information retrieval with text generation. This approach leverages external knowledge sources to provide accurate, contextually relevant, and up-to-date recommendations. By combining retrieval mechanisms with generative models, RAG systems may offer more precise and tailored suggestions, improving user satisfaction and decision-making in specialized domains.

In one aspect, the invention may be a computer method of selecting a foundational building block model from a trained dataset of foundational building block models, comprising performing a semantic similarity search of the trained dataset, based on a user specification, to produce a set of foundational building block model candidates. The specification may be conveyed to the trained dataset through an initial prompt. The method may further comprise combining the initial prompt from the user with the set of foundational building block model candidates to produce an augmented prompt, submitting the augmented prompt to a primary large language model (LLM), and receiving, from the primary LLM, a prioritized categorization of the final set of foundational building block candidates generated based, at least in part, on the specification from the user.

The method may further comprise performing a multi-stage reranking of the set of foundational building block model candidates. The method may further comprise performing a first stage of the multistage reranking using an encoder such as, but not limited to, a Bi-encoder and performing a second stage of the multistage reranking performed using a Cross-encoder. The method may further comprise the user iteratively prompting the primary LLM to further refine the selection of the foundational building block model. The method may further comprise performing the semantic similarity search of the trained dataset using one or more encoders such as, but not limited to, Bi-encoders. In an embodiment, the Bi-encoder may further comprise a cascade of one or more successive Bi-encoders, and the Cross-encoder may further comprise a cascade of one or more successive Cross-encoders. The cascade of one or more successive Bi-encoders may comprise, but is not limited to, one or more of (i) All-miniLM-L6, (ii) Baai-Bge-small, (iii) Baai-Bge-Large, (iv) Mpnet, (v) Roberta-base, or (vi) Specter. The cascade of one or more successive Cross-encoders may comprise, but is not limited to, one or more of (i) Electra-base, (ii) MiniLM-L-12, (iii) MiniLM-L-6, (iv) MiniLM-L-4, or (v) TinyBERT-L-4.

The method may further comprise training the training dataset by (i) cleaning an initial dataset of foundational building block models to eliminate duplicate versions of the foundational building block models, (ii) summarizing each cleaned entry of the dataset of foundational building block models with a training LLM, (iii) converting each cleaned, summarized entry of the dataset of foundational building block models into a structured format, and (iv) using a Bi-encoder, encoding the cleaned, summarized, formatted foundational building block models into vectors. The prioritized categorization of the final set of foundational building block candidates further includes descriptions of one or more characteristics of the final set of foundational building block candidates relevant to the user specification.

In another aspect, the invention may be a system for selecting a foundational building block model from a trained dataset of foundational building block models, comprising a processor and a memory with computer code instructions stored thereon. The memory may be operatively coupled to the processor such that, when executed by the processor, the computer code instructions cause the system to perform a semantic similarity search of the trained dataset, based on a user specification, to produce a set of foundational building block model candidates, the specification conveyed to the trained dataset through an initial prompt, combine the initial prompt from the user with the final set of foundational building block model candidates to produce an augmented prompt, submit the augmented prompt to a primary large language model (LLM), and receive, from the primary LLM, a prioritized categorization of the final set of foundational building block candidates generated based, at least in part, on the specification from the user.

The computer code instructions may further cause the system to perform a multi-stage reranking of the set of foundational building block model candidates. The computer code instructions may further cause the system to perform a first stage of the multistage reranking using a first encoder and a second stage of the multistage reranking using a second encoder wherein said first and second encoders can be of the same type or different types. The computer code instructions may further cause the system to perform a first stage of the multistage reranking using a Bi-encoder. The computer code instructions may further cause the system to perform a second stage of the multistage reranking performed using a Cross-encoder.

The computer code instructions may further cause the system to perform a first stage of the multistage reranking using a Bi-encoder and perform a second stage of the multistage reranking performed using a Cross-encoder. The system may be responsive to the user iteratively prompting the primary LLM to further refine the selection of the foundational building block model. The computer code instructions may further cause the system to perform the semantic similarity search of the trained database using one or more Bi-encoders. The Bi-encoder may further comprises a cascade of one or more successive Bi-encoders, and the Cross-encoder further comprises a cascade of one or more successive Cross-encoders. The cascade of one or more successive Bi-encoders may comprise, but is not limited to, one or more of (i) All-miniLM-L6, (ii) Baai-Bge-small, (iii) Baai-Bge-Large, (iv) Mpnet, (v) Roberta-base, or (vi) Specter. The cascade of one or more successive Cross-encoders may comprise, but is not limited to, one or more of (i) Electra-base, (ii) MiniLM-L-12, (iii) MiniLM-L-6, (iv) MiniLM-L-4, or (v) TinyBERT-L-4. To train the trained dataset (i) an initial dataset of foundational building block models may be cleaned to eliminate duplicate versions of the foundational building block models, (ii) each cleaned entry of the dataset of foundational building block models may be trained with a training LLM, (iii) each cleaned, summarized entry of the dataset of foundational building block models may be converted into a structured format, (iv) the cleaned, summarized, formatted foundational building block models may be encoded into vectors using a Bi-encoder. The prioritized categorization of the final set of foundational building block candidates may further include descriptions of one or more characteristics of the final set of foundational building block candidates relevant to the user specification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 illustrates an example embodiment of the procedure used to train the dataset.

FIG. 2 shows an example architecture for evaluating the effectiveness of re-ranking.

FIG. 3 shows an example interface that may be used to select multiple combinations of Bi-Encoder and Cross-encoder models, based on the architecture shown in FIG. 2.

FIG. 4 illustrates an example workflow for the recommendation system of the described embodiments.

FIG. 5 shows a user interface of an example recommendation system

FIG. 6 shows results obtained from evaluating the prompts with each of the candidate Bi-encoder models.

FIGS. 7 and 8 provide a comparison of each Bi-encoder model combined with the different Cross-encoders.

### DETAILED DESCRIPTION

A description of example embodiments follows.

The embodiments described herein are directed to a computer-based method of selecting (also referred to herein as recommending) a foundational building block model from a trained dataset of foundational building blocks.

The dataset is initially generated by extracting information from two sources. The first source is an existing library of Register-Transfer Level (RTL) foundational models that are implemented in a hardware description language such as Verilog or VHDL. The second source is the microarchitecture documentation associated with each RTL model (available on, for example, the team collaboration tool Confluence). While example embodiments described herein utilize RTL models associated with an integrated circuit design environment, any family of foundational models may alternatively be used.

This example dataset may include comprehensive details from both sources to provide a consolidated view of the relevant information for each foundational model. Those comprehensive details may include:
Family. The family to which the RTL model implementation belongs (e.g., FIFO, Arbiters, Counters, etc.).
Input/Output. A list of inputs and outputs for the RTL model.
Parameters. The parameters associated with the model.
Description A summary of the model.
Theory of Operation. Micro-architectural insights including finite state machines (FSMs), timing diagrams and logic design details.
Physical implementation details. details on various aspects such as the area, levels of logic, combinational cell count, sequential cell count, and power consumption.

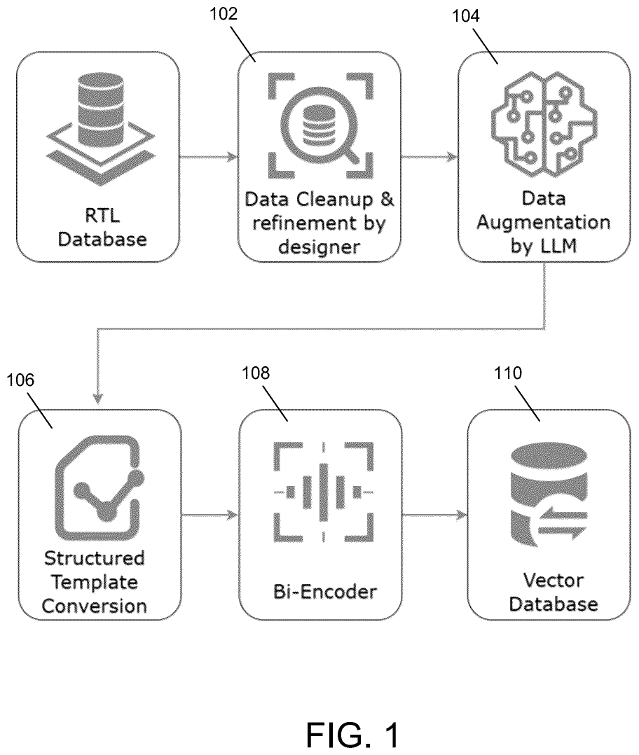

FIG. 1 illustrates an example embodiment of the procedure used to train the dataset. Training begins by cleaning 102 the dataset to eliminate duplicate versions of the RTL models. The summarization capabilities of large language models (LLMs) are leveraged to transform 104 long descriptions into concise summaries, preserving the critical aspects of the RTL models. The processed text is first converted 106 into JavaScript Object Notation (JSON) format, then passed through one or more Bi-encoders 108 that encode the dataset into vectors. These vectors are stored and managed in a vector database 110 using, for example, Chroma DB.

To ensure optimal performance, multiple Bi-encoders such as, but not limited to, All-miniLM-L6, Baai-Bge-small, Baai-Bge-Large, Mpnet, Roberta-base, and Specter were employed in the process, facilitating selection of the best encoder.

After creating a vector database as described with respect to FIG. 1, Cross-encoders were integrated to re-rank the search results generated by Bi-encoders based on their relevance to a given query as shown. Cross encoders used for model selection can be, but are not limited to, Electra-base, MiniLM-L-12, MiniLM-L-6, MiniLM-L-4, TinyBERT-L-4.

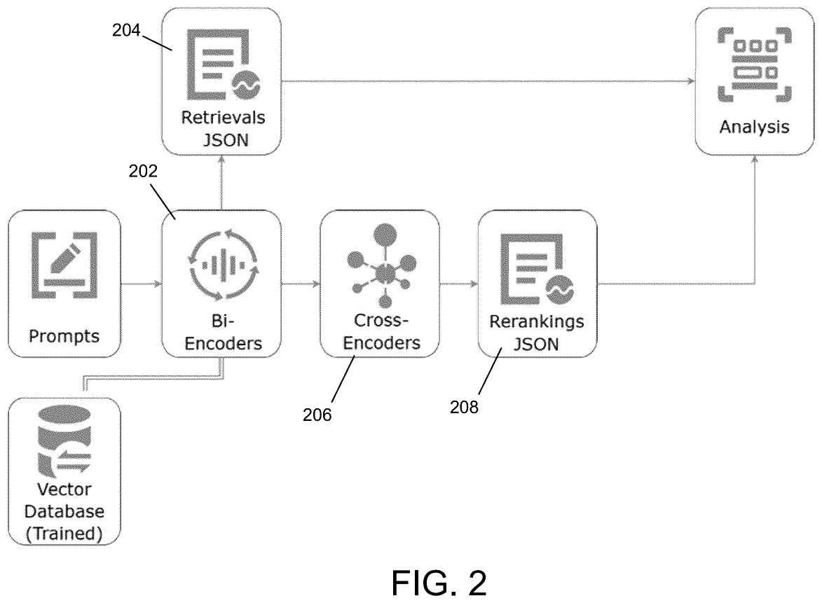

To evaluate the effectiveness of re-ranking, results were extracted at two levels: one set of results from the Bi-encoders 202, referred to as the Retrievals JSON 204, and the other set of results from the Cross-encoders 206, referred to as the Reranking JSON 208, as shown in FIG. 2. Additionally, we maintained a Baseline JSON containing the golden results for a variety of prompts used during model selection. Scores were calculated by comparing Retrieval JSON 204 and Reranking JSON 208 with Baseline JSON to select the most suitable model.

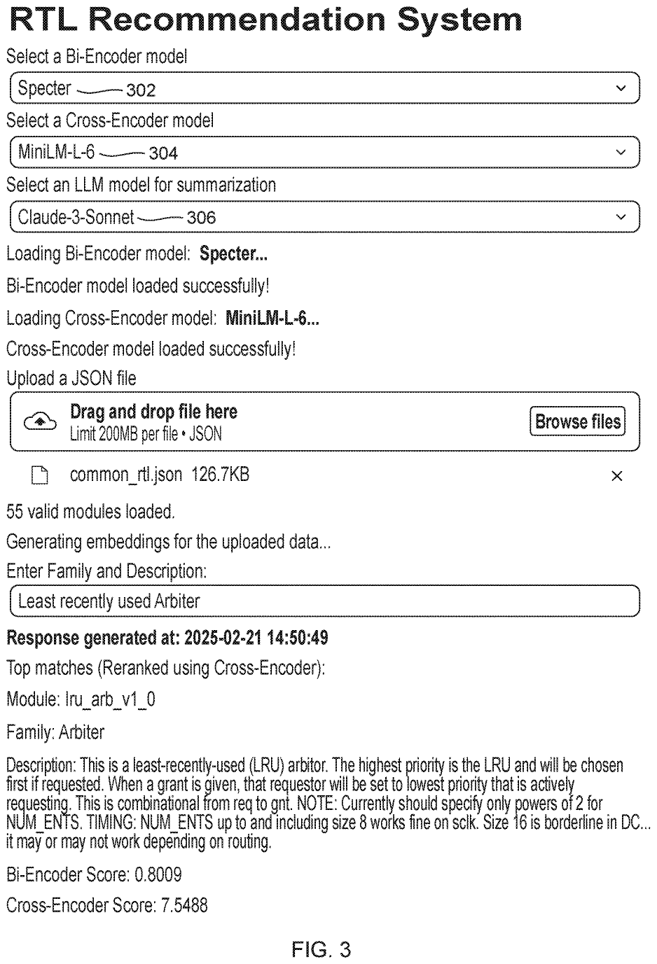

FIG. 3 shows an example interface that may be used to select multiple combinations of Bi-Encoder and Cross-encoder models, based on the architecture shown in FIG. 2, with results displayed. In this example, Specter was selected for the Bi-encoder model 302, MiniLM-L-6 was selected for the Cross-encoder model 304, and Claude-3-Sonnet was selected for the LLM model 306 for summarization.

Once the appropriate Bi-encoders and Cross-encoders are determined, an approach of multi-stage re-ranking is adopted to enhance the re-ranking performance. The multi-stage re-ranking approach uses fast re-ranking in the first stage, followed by accurate re-ranking in the second stage. Fast re-ranking models (e.g., Bi-encoding models) are simple and fast models that can quickly narrow down a large volume of dataset vectors to a smaller set of vectors. The accurate re-ranking models (e.g., Cross-encoding models) aim to improve the fast ranking by ensuring that the results are as relevant and accurate as possible. The accurate re-ranking models take the smaller subset of results generated in the fast re-ranking stage and apply more advanced, computationally intensive models to precisely evaluate their relevance.

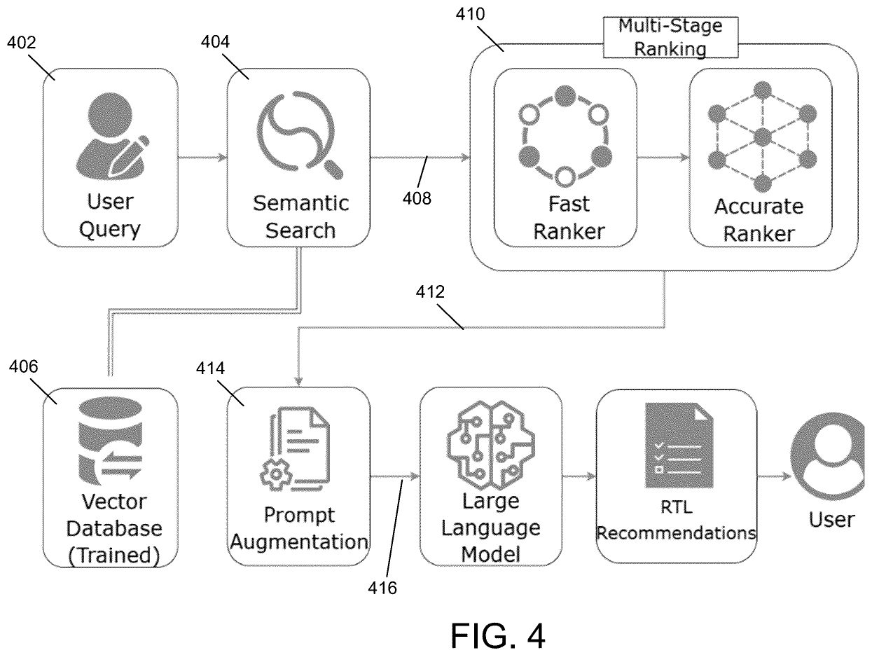

The workflow for recommendation system is illustrated in FIG. 4. Bi-encoders perform semantic searches 402 by measuring the semantic similarity between user query 404 and the text embeddings stored in the vector database 406. This gives an initial set of recommendations 408 that are passed on to multi-stage reranking 410 to refine the RTL module selection. The retrieved information 412 is integrated into the original prompt for prompt augmentation 414. This augmented prompt 416 is then passed to the large language model (LLM) 418 to produce a more informed and contextually accurate response of RTL recommendations 420.

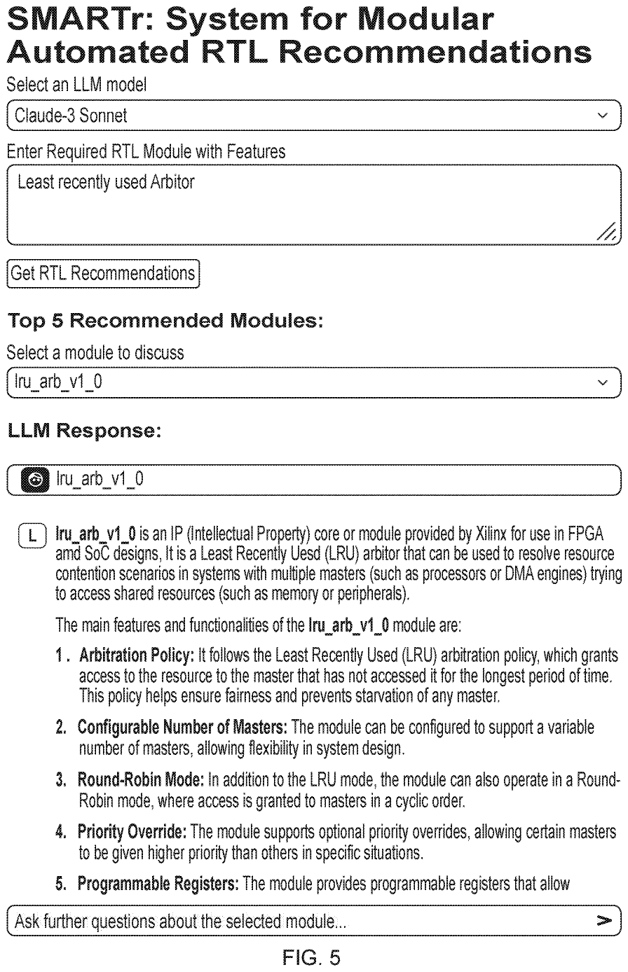

FIG. 5 shows a user interface of an example recommendation system, which lets a user select an LLM and enter a query describing the RTL module for which the user is searching. The example recommendation system then provides the top five most relevant RTL module recommendations.

To assess the efficacy of the example recommendation system, a series of evaluations were conducted using diverse prompts that encapsulate various user requirements. These tests aimed to examine the system's ability to generate foundational module recommendations based on the outputs produced in response to different user prompts.

To evaluate performance, a baseline dataset was established comprising user queries and the corresponding correct model choices. Scores for both re-ranking and non-re-ranking tests were calculated by comparing the model recommendations against the baseline data.

The performance of the example recommendation system was evaluated by comparing a ranking-based approach (single-stage ranking) with a re-ranking-based approach (multi-stage ranking). Initially, user queries using Bi-encoders were evaluated to obtain the baseline (i.e., no re-ranking) results. Subsequently, Cross-encoders were employed to re-rank the Bi-encoder recommendations for multi-stage ranking. The testing results indicate that re-ranking significantly enhances the quality of the recommendations.

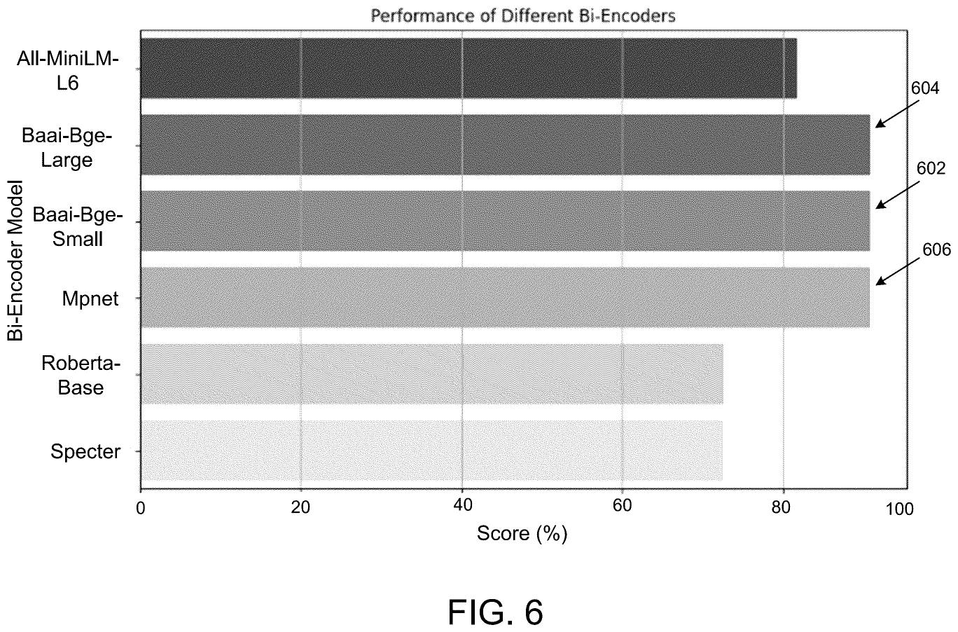

The tests are designed to determine the optimal foundational module recommendation, along with identifying the top five foundational module recommendations. In the case of no re-ranking, the results obtained from evaluating the prompts with all Bi-encoder models is shown in FIG. 6. As indicated, the models which performed the best for this case are, but are not limited to, Baai-Bge-Small 602, Baai-Bge-Large 604, and Mpnet 606.

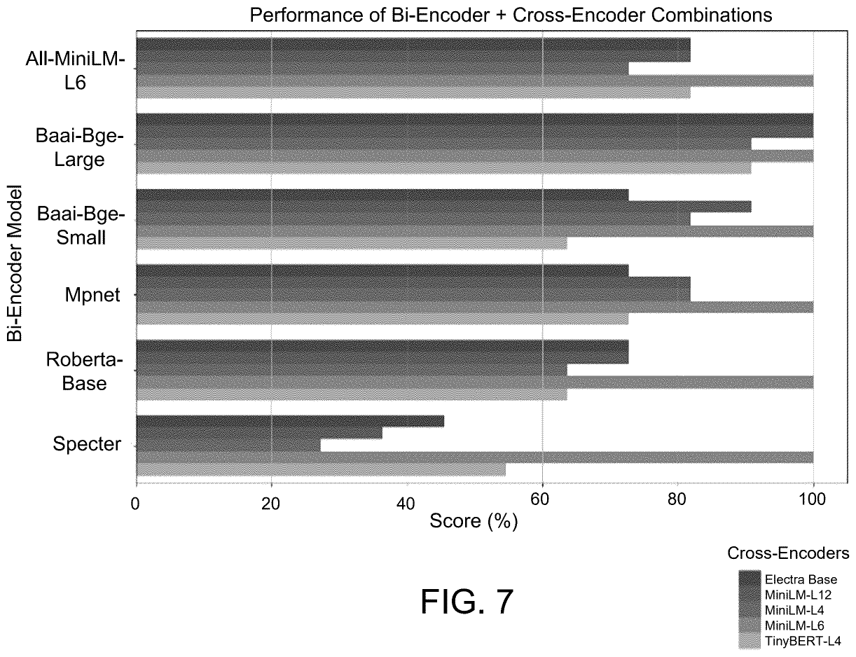

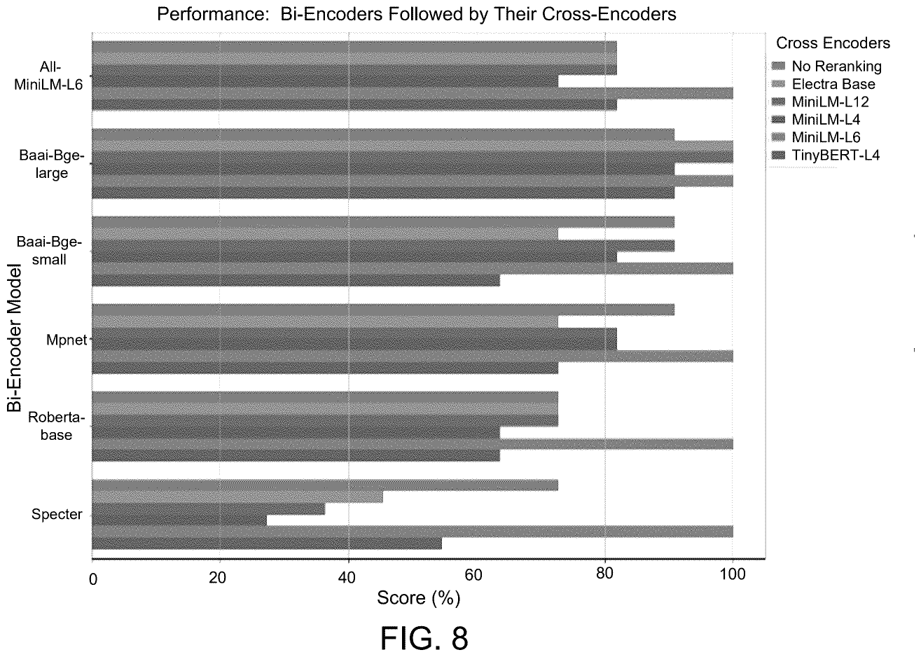

To further enhance the system's accuracy, Cross-encoders were implemented following the Bi-encoders to better meet user needs and preferences. Tests involved running the data through each Bi-encoder and then refining the results using each Cross-encoder. From the test results, the most effective Cross-encoder was MiniLM-L6, which achieved the highest score with all Bi-encoder models. The graphs in FIGS. 7 and 8 illustrate the comparison of each Bi-encoder model combined with the different Cross-encoders. The top combinations of Bi-encoder and Cross-encoder are Baai-Bge-Large, Baai-Bge-Small, All-MiniLM-L6, and Mpnet. The testing thus shows the re-ranking approach significantly increases the quality of the recommendations.

Table I shows the results for the single-stage ranking as compared to multi-stage ranking scores for all the Bi-encoder models with the Cross-encoder model All-MiniLM-L6.

TABLE I

| | Bi- | Cross | Percentage |
|---|---|---|---|
| Model | Encoder | Encoder | Change |
| All-MiniLM-L6 | 81.82 | 100 | 22.21 |
| Baai-Bge-Large | 90.91 | 100 | 9.99 |
| Baai-Bge-Small | 90.91 | 100 | 9.99 |
| MPNET | 90.91 | 100 | 9.99 |
| Roberta | 72.73 | 100 | 37.49 |
| Specter | 72.73 | 100 | 37.49 |

The scoring is calculated by comparing the predicted recommendations with the baseline records. For each prompt, if at least one of the five predicted results matches any of the values in the baseline, it is considered a correct match. The final score is determined as the percentage of correct matches over the total number of prompts.

The embodiments described herein are directed to an AI-powered recommendation system designed to assist RTL engineers in selecting the most suitable foundational RTL modules. By integrating Retrieval-Augmented Generation (RAG) with Bi-encoders and Cross-encoders, we developed an efficient framework that automates the retrieval, ranking, and recommendation of RTL components based on user-defined specifications. Our approach significantly reduces the manual effort involved in module selection while improving accuracy and consistency in the design process.

The results demonstrate that leveraging Bi-encoders such as, but not limited to, All-MiniLM-L6, Baal-Bge-Large, and MPNet, followed by Cross-encoder-based re-ranking, enhances recommendation precision. As shown in our analysis, models incorporating re-ranking outperformed those relying solely on Bi-encoder retrieval, leading to a more refined selection of RTL modules. The evaluation further indicated that the All-MiniLM-L6 model, in combination with a Cross-encoder, achieved the highest-ranking performance.

Furthermore, integrating multi-modal learning techniques, including schematic and waveform-based embeddings, improves the contextual understanding of RTL components and further enhances recommendation accuracy. Expanding the dataset to include more diverse RTL libraries and real-world user feedback also strengthens the system's adaptability.

AI-driven design may be broadened to automation in semiconductor development. As AI models continue to evolve, integrating generative AI with hardware design tools will become increasingly critical in optimizing chip design processes. Our research lays the foundation for future AI-assisted RTL automation frameworks, aiming to streamline verification, reduce development costs, and accelerate innovation in chip design.

While example embodiments have been particularly shown and described, it will be understood by those skilled in the art that various changes in form and details may be made therein without departing from the scope of the embodiments encompassed by the appended claims.

What is claimed is:

1. A computer method of selecting a foundational building block model from a trained dataset of foundational building block models, comprising:
performing a semantic similarity search of the trained dataset, based on a user specification, to produce a set of foundational building block model candidates, the specification conveyed to the trained dataset through an initial prompt;
combining the initial prompt from the user with the set of foundational building block model candidates to produce an augmented prompt;
submitting the augmented prompt to a primary large language model (LLM); and
receiving, from the primary LLM, a prioritized categorization of the final set of foundational building block candidates generated based, at least in part, on the specification from the user.

2. The method of claim 1, further comprising performing a multi-stage reranking of the set of foundational building block model candidates.

3. The method of claim 2, further comprising performing a first stage of the multistage reranking using a first encoder and performing a second stage of the multistage reranking performed using a second encoder wherein the first and second encoders can be of the same type or different types.

4. The method of claim 3, wherein the first encoder is a Bi-encoder.

5. The method of claim 3, wherein the second encoder is a Cross-encoder.

6. The method of claim 3, wherein the first encoder is a Bi-encoder and the second encoder is a Cross-encoder.

7. The method of claim 1, further comprising the user iteratively prompting the primary LLM to further refine the selection of the foundational building block model.

8. The method of claim 1, further comprising performing the semantic similarity search of the trained dataset using one or more Bi-encoders.

9. The method of claim 6, wherein the Bi-encoder further comprises a cascade of one or more successive Bi-encoders, and the Cross-encoder further comprises a cascade of one or more successive Cross-encoders.

10. The method of claim 9, wherein the cascade of one or more successive Bi-encoders comprises one or more of (i) All-miniLM-L6, (ii) Baai-Bge-small, (iii) Baai-Bge-Large, (iv) Mpnet, (v) Roberta-base, or (vi) Specter.

11. The method of claim 9, wherein the cascade of one or more successive Cross-encoders comprises one or more of (i) Electra-base, (ii) MiniLM-L-12, (iii) MiniLM-L-6, (iv) MiniLM-L-4, or (v) TinyBERT-L-4.

12. The method of claim 1, further comprising training the training dataset by (i) cleaning an initial dataset of foundational building block models to eliminate duplicate versions of the foundational building block models, (ii) summarizing each cleaned entry of the dataset of foundational building block models with a training LLM, (iii) converting each cleaned, summarized entry of the dataset of foundational building block models into a structured format, and (iv) using a Bi-encoder, encoding the cleaned, summarized, formatted foundational building block models into vectors.

13. The method of claim 1, wherein the prioritized categorization of the final set of foundational building block candidates further includes descriptions of one or more characteristics of the final set of foundational building block candidates relevant to the user specification.

14. A system for selecting a foundational building block model from a trained dataset of foundational building block models, comprising:
a processor; and
a memory with computer code instructions stored thereon, the memory operatively coupled to the processor such that, when executed by the processor, the computer code instructions cause the system to:
perform a semantic similarity search of the trained dataset, based on a user specification, to produce a set of foundational building block model candidates, the specification conveyed to the trained dataset through an initial prompt;
combine the initial prompt from the user with the final set of foundational building block model candidates to produce an augmented prompt;
submit the augmented prompt to a primary large language model (LLM); and
receive, from the primary LLM, a prioritized categorization of the final set of foundational building block candidates generated based, at least in part, on the specification from the user.

15. The system of claim 14, wherein when executed by the processor, the computer code instructions further cause the system to perform a multi-stage reranking of the set of foundational building block model candidates.

16. The system of claim 15, wherein when executed by the processor, the computer code instructions further cause the system to perform a first stage of the multistage reranking using a first encoder and a second stage of the multistage reranking using a second encoder wherein said first and second encoders can be of the same type or different types.

17. The system of claim 15, wherein when executed by the processor, the computer code instructions further cause the system to perform a first stage of the multistage reranking using a Bi-encoder.

18. The system of claim 15, wherein when executed by the processor, the computer code instructions further cause the system to perform a second stage of the multistage reranking performed using a Cross-encoder.

19. The system of claim 15, wherein when executed by the processor, the computer code instructions further cause the system to perform a first stage of the multistage reranking using a Bi-encoder and perform a second stage of the multistage reranking performed using a Cross-encoder.

20. The system of claim 14, wherein the system is responsive to the user iteratively prompting the primary LLM to further refine the selection of the foundational building block model.

21. The system of claim 14, wherein when executed by the processor, the computer code instructions further cause the system to perform the semantic similarity search of the trained database using one or more Bi-encoders.

22. The system of claim 21, wherein the Bi-encoder further comprises a cascade of one or more successive Bi-encoders, and the Cross-encoder further comprises a cascade of one or more successive Cross-encoders.

23. The system of claim 22, wherein the cascade of one or more successive Bi-encoders comprises one or more of (i) All-miniLM-L6, (ii) Baai-Bge-small, (iii) Baai-Bge-Large, (iv) Mpnet, (v) Roberta-base, or (vi) Specter.

24. The system of claim 22, wherein the cascade of one or more successive Cross-encoders comprises one or more of (i) Electra-base, (ii) MiniLM-L-12, (iii) MiniLM-L-6, (iv) MiniLM-L-4, or (v) TinyBERT-L-4.

25. The system of claim 14, wherein to train the trained dataset (i) an initial dataset of foundational building block models is cleaned to eliminate duplicate versions of the foundational building block models, (ii) each cleaned entry of the dataset of foundational building block models is trained with a training LLM, (iii) each cleaned, summarized entry of the dataset of foundational building block models is converted into a structured format, (iv) the cleaned, summarized, formatted foundational building block models is encoded into vectors using a Bi-encoder.

26. The system of claim 11, wherein the prioritized categorization of the final set of foundational building block candidates further includes descriptions of one or more characteristics of the final set of foundational building block candidates relevant to the user specification.

27. A system for selecting a foundational building block model from a trained dataset of foundational building block models, comprising:
means for performing a semantic similarity search of the trained dataset, based on a user specification, to produce a set of foundational building block model candidates, the specification conveyed to the trained dataset through an initial prompt;
means for combining the initial prompt from the user with the final set of foundational building block model candidates to produce an augmented prompt;
means for submitting the augmented prompt to a primary large language model (LLM); and
means for receiving, from the primary LLM, a prioritized categorization of the final set of foundational building block candidates generated based, at least in part, on the specification from the user.
